(19) United States
(12) Patent Application Publication
(10) Pub. No.: US 2022/0307306 A1
(43) Pub. Date: Sep. 29, 2022

(54) METHOD FOR INSTALLING A GUIDE ASSEMBLY FOR A MOVABLE FURNITURE PART

(71) Applicant: Julius Blum GmbH, Hoechst (AT)

(72) Inventors: Bernd KOENIG, Hoechst (AT); Matthias RUPP, Hohenweiler (AT); Thomas SPERGER, Hard (AT)

(21) Appl. No.: 17/839,879

(22) Filed: Jun. 14, 2022

Related U.S. Application Data
(63) Continuation of application No. PCT/AT2020/060458, filed on Dec. 11, 2020.

(30) Foreign Application Priority Data
Dec. 19, 2019 (AT) GM 50233/2019

(51) Int. Cl. E05D 15/26; E05C 17/60

(52) U.S. Cl. CPC E05D 15/264; E05D 13/04; E05Y 2201/684; E05Y 2600/452; E05Y 2600/50; E05Y 2900/20

(57) ABSTRACT

A method for installing a guide assembly for a movable furniture part includes preferably carrying out chronologically in the following order: arranging on the furniture wall a first guide rail for guiding the movable furniture part, and arranging on a first longitudinal side of the first guide rail a drive device for influencing the movement of the movable furniture part on the furniture wall, the first guide rail and the drive device preferably being connected together. If the movable furniture part comprises at least two door leaves connected together in an articulated manner, arranging a second guide rail for guiding the movable furniture part on the furniture wall on a second longitudinal side of the first guide rail, the first guide rail and the second guide rail preferably being connected together in a form-fitting and/or movable manner in particular.

### BACKGROUND OF THE INVENTION

The invention relates to a method for installing a guide assembly for a movable furniture part, which comprises either precisely one door leaf or at least two door leaves connected to each other in an articulated manner, on a furniture wall of a stationary furniture part. The invention furthermore relates to a method for installing a piece of furniture in which the method for installing a guide assembly is used.

Methods are already known from the state of the art. Different guide assemblies are used there depending on whether the movable furniture part to be guided by means of the guide assembly comprises precisely one door leaf or at least two door leaves connected to each other in an articulated manner.

A disadvantage is that the installer has to keep both versions of the guide assembly in stock, unless handling only guide assemblies for one type of the movable furniture part to be guided. Furthermore, the production of the guide assemblies is associated with high costs, as the guide assemblies are formed differently and therefore two production lines are needed.

### SUMMARY OF THE INVENTION

The object of the present invention is to avoid these disadvantages at least in part and to specify a method that is improved compared with the state of the art for installing a guide assembly for a movable furniture part, which comprises either precisely one door leaf or at least two door leaves connected to each other in an articulated manner, on a furniture wall of a stationary furniture part, which method gives an installer in particular a greater flexibility in the production of pieces of furniture and is associated with lower production costs on the manufacturer's part. Furthermore, a method for installing a piece of furniture in which the improved method for installing a guide assembly is used is to be specified.

In the method according to the invention for installing a guide assembly for a movable furniture part, which comprises either precisely one door leaf or at least two door leaves connected to each other in an articulated manner, on a furniture wall of a stationary furniture part, the method steps are therefore provided, preferably chronological in the specified sequence:
a first guide rail for guiding the movable furniture part is arranged on the furniture wall,
at least one drive device for influencing the movement of the movable furniture part on the furniture wall is arranged on a first long side of the first guide rail, preferably wherein the first guide rail and the at least one drive device are connected to each other, particularly preferably in a positive-locking manner, and
in the case that the movable furniture part comprises at least two door leaves connected to each other in an articulated manner, a second guide rail for guiding the movable furniture part on the furniture wall is arranged on a second long side of the first guide rail, preferably wherein the first guide rail and the second guide rail are connected to each other, particularly preferably in a positive-locking manner and/or displaceably.

It is thereby possible to assemble the guide assembly from a type of kit, wherein as many common parts as possible are used, which are used both in the case of a guide assembly for a movable furniture part which comprises precisely one door leaf and in the case of a guide assembly for a movable furniture part which comprises at least two door leaves connected to each other in an articulated manner.

The common parts can be manufactured in larger quantities and on the same production line, as a result of which the costs of the production of the guide assembly are lowered.

According to a preferred embodiment of the method, the same first guide rail and/or the same drive device is involved irrespective of whether the movable furniture part comprises precisely one door leaf or at least two door leaves connected to each other in an articulated manner. As a result, the number of common parts can be increased.

It has proved to be advantageous that, in the case that the movable furniture part comprises precisely one door leaf, in a further method step at least one holding device for holding the movable furniture part in an end position relative to the first guide rail on the furniture wall is arranged on the second long side of the first guide rail, preferably wherein the first guide rail and the at least one holding device are connected to each other, particularly preferably in a positive-locking manner and/or displaceably. It is thereby possible to move the movable furniture part into a defined end position relative to the first guide rail by means of the guide assembly, as a result of which the risk of damage originating from a faulty operation of the furniture part is reduced.

As an alternative or supplement, in a further method step a third guide rail for guiding the movable furniture part on the furniture wall is arranged at a distance from the first guide rail. Preferably, the same third guide rail is involved irrespective of whether the movable furniture part comprises precisely one door leaf or at least two door leaves connected to each other in an articulated manner. The movable furniture part can thereby be guided particularly stably on the furniture wall by means of the guide assembly.

A particularly harmonic movement of the movable furniture part to be guided by means of the guide assembly can be produced in that in a further method step at least one damping device for damping a movement of the movable furniture part, preferably into an end position relative to the first guide rail, on the furniture wall is arranged at a distance from the first guide rail. Preferably, the same damping device is involved irrespective of whether the movable furniture part comprises precisely one door leaf or at least two door leaves connected to each other in an articulated manner.

It is favorably suitable that in a further method step at least one carrier for the articulated mounting of the movable furniture part is mounted displaceably on the guide rails provided, preferably wherein the same carrier is involved irrespective of whether the movable furniture part comprises precisely one door leaf or at least two door leaves connected to each other in an articulated manner. The installation is thereby made easier, as the carrier can first be installed on the guide rails provided and then the movable furniture part only has to be connected to the carrier.

In this connection, it has proved to be advantageous that at least one compensation device for compensating for a tilt moment of the at least one carrier or of the movable furniture part arranged thereon about a tilt axis by a restoring moment is arranged on the at least one carrier and in a further method step the at least one compensation device is connected to the furniture wall, preferably to the at least one drive device arranged on the furniture wall. As a result, the risk of a canting of the movable furniture part to be guided by means of the guide assembly can be reduced.

Protection is also sought for a method for installing a piece of furniture with at least one stationary furniture part, at least one movable furniture part, which comprises either precisely one door leaf or at least two door leaves connected to each other in an articulated manner, and at least one guide assembly for the movable furniture part. First, the at least one guide assembly is mounted according to the method according to the invention on a furniture wall of the at least one stationary furniture part, and then the movable furniture part is mounted displaceably at least on the first guide rail, preferably indirectly via at least one carrier.

In an advantageous embodiment, in the case that the movable furniture part comprises at least two door leaves connected to each other in an articulated manner, in a further method step the at least two door leaves are connected to each other in an articulated manner via at least two door hinges.

As an alternative or supplement, in the case that the movable furniture part comprises at least two door leaves connected to each other in an articulated manner, in a further method step at least one transverse guide rail is arranged transverse to the first guide rail on the at least one stationary furniture part and one of the at least two door leaves of the movable furniture part is connected to the at least one transverse guide rail via at least one carriage. The movable furniture part can thereby be guided securely by means of the guide assembly in any position.

In this connection, it has proved to be advantageous that in a further method step the at least one transverse guide rail is covered at least in regions by at least one screen element. An esthetically advantageous appearance of the piece of furniture to be installed can thereby be achieved.

### BRIEF DESCRIPTION OF THE DRAWINGS

Further details and advantages of the invention are explained in more detail below by means of the description of the figures with reference to the drawings. There are shown in:

FIG. 1 is a schematically represented perspective view of a piece of furniture with a movable furniture part which comprises precisely one door leaf and a movable furniture part which comprises two door leaves connected to each other in an articulated manner,

FIG. 2 is a schematically represented perspective view of a piece of furniture with a movable furniture part which comprises two door leaves connected to each other in an articulated manner,

FIG. 3 is a schematically represented perspective view of a furniture wall of a stationary furniture part of a piece of furniture with a movable furniture part which comprises at least two door leaves connected to each other in an articulated manner,

FIG. 4 shows the furniture wall according to FIG. 3 with a first and a third guide rail,

FIG. 5 shows the furniture wall according to FIG. 4, additionally with a second guide rail,

FIGS. 6a, 6b show the furniture wall according to FIG. 5 additionally with a drive device and a damping device, wherein partial FIG. 6a shows a schematically represented perspective view and partial FIG. 6b shows a schematically represented side view from behind, wherein a carrier mounted displaceably on the first and second guide rails is additionally represented in partial FIG. 6b,

FIG. 7 shows the furniture wall according to FIG. 6a additionally with a carrier,

FIG. 8 shows the furniture wall according to FIG. 7, wherein a compensation device arranged on the carrier is connected to the drive device,

FIG. 9 is a schematically represented perspective view of a furniture wall of a stationary furniture part of a piece of furniture with a movable furniture part which comprises precisely one door leaf,

FIG. 10 shows the furniture wall according to FIG. 9 with a first guide rail,

FIGS. 11a, 11b show the furniture wall according to FIG. 10 additionally with a drive device, wherein partial FIG. 11a shows a schematically represented perspective view and partial FIG. 11b shows a schematically represented side view from behind,

FIG. 12a shows the furniture wall according to FIG. 11a additionally with a damping device, a third guide rail and a holding device,

FIG. 12b is the enlarged view from FIG. 11b, wherein the drive device is fastened on the furniture wall via a holding element,

FIG. 13 shows the furniture wall according to FIG. 12a additionally with a carrier, and

FIGS. 14a, 14b are, in each case, a schematically represented perspective view of a holding device for holding a movable furniture part which comprises precisely one door leaf, wherein partial FIG. 14a shows a holding position and partial FIG. 14b shows a release position.

### DETAILED DESCRIPTION OF THE INVENTION

FIG. 1 shows a piece of furniture 24 with a movable furniture part 4 which comprises precisely one door leaf 4 and a movable furniture part 3 which comprises two door leaves 5, 6 connected to each other in an articulated manner. In each case an interior 49, in which kitchen appliances and/or kitchen furniture can be arranged for example, can be covered by the movable furniture parts 3, 4. In this way, a concealable kitchen can be produced.

Unlike what is represented in FIG. 1, there can also be a common interior 49 which can be covered from a first side by the movable furniture part 3 and from a second side by the movable furniture part 4.

The piece of furniture 24 comprises cavities 28, which extend in a depth direction 22 of the piece of furniture 24, are preferably formed shaft-shaped and in which the movable furniture parts 3, 4 can be arranged.

In each case a guide assembly 1 arranged on a furniture wall 7 of a stationary furniture part 8 is installed for guiding the movable furniture parts 3, 4 in the cavities 28.

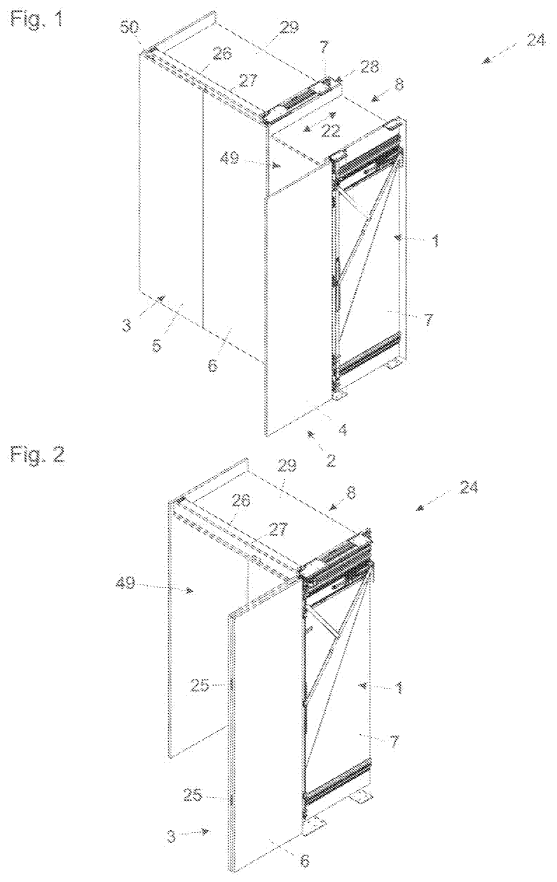

FIG. 2 shows a piece of furniture 24 with a movable furniture part 3 which comprises two door leaves 5, 6 connected to each other in an articulated manner. The door leaves 5, 6 are connected to each other in an articulated manner via door hinges 25.

A transverse guide rail 26 is arranged on a top panel 29 of the piece of furniture 24, wherein one of the two door leaves 5, 6 of the movable furniture part 3 is mounted displaceably on the transverse guide rail 26 via a carriage 50 (cf. also FIG. 1). The transverse guide rail 26 is covered in regions by a screen element 27.

In addition to the pieces of furniture 24 represented in FIGS. 1 and 2, pieces of furniture 24 which have only one movable furniture part 4 which comprises precisely one door leaf 4 or pieces of furniture 24 with more than one movable furniture part 3 and/or more than one movable furniture part 4 are also conceivable.

The present invention relates, according to a first aspect, to a method for installing a guide assembly 1 for a movable furniture part 2, 3, which comprises either precisely one door leaf 4 or at least two door leaves 5, 6 connected to each other in an articulated manner, on a furniture wall 7 of a stationary furniture part 8, comprising the method steps, preferably chronological in the specified sequence:
a first guide rail 9 for guiding the movable furniture part 2, 3 is arranged on the furniture wall 7,
at least one drive device 11 for influencing the movement of the movable furniture part 2, 3 on the furniture wall 7 is arranged on a first long side 10 of the first guide rail 9, preferably wherein the first guide rail 9 and the at least one drive device 11 are connected to each other, particularly preferably in a positive-locking manner, and
in the case that the movable furniture part 3 comprises at least two door leaves 5, 6 connected to each other in an articulated manner, a second guide rail 13 for guiding the movable furniture part 3 on the furniture wall 7 is arranged on a second long side 12 of the first guide rail 9, preferably wherein the first guide rail 9 and the second guide rail 13 are connected to each other, particularly preferably in a positive-locking manner and/or displaceably.

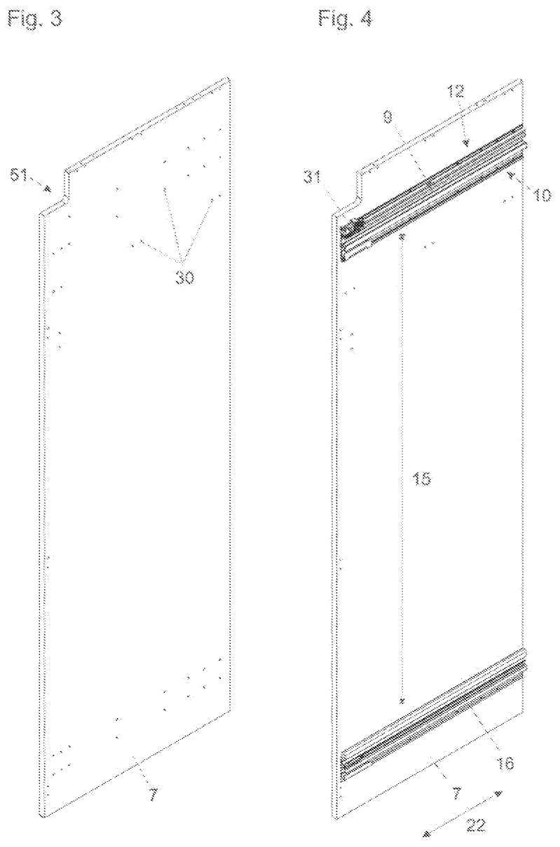

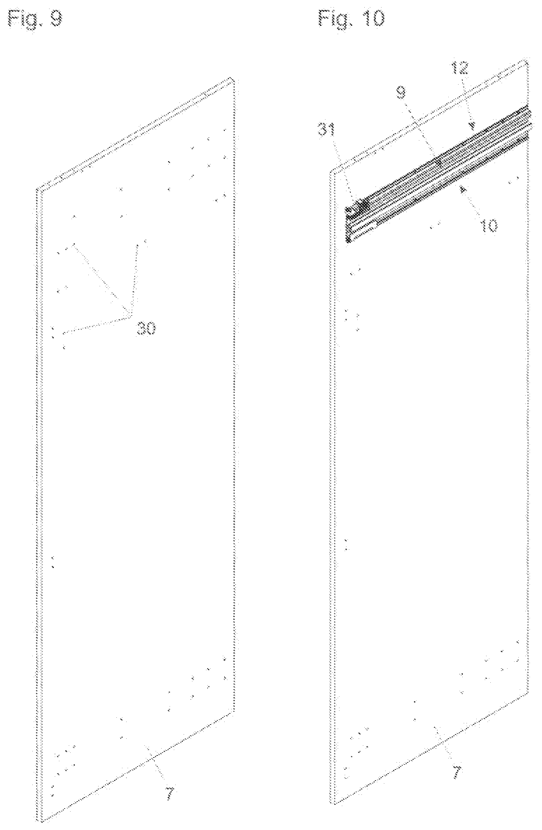

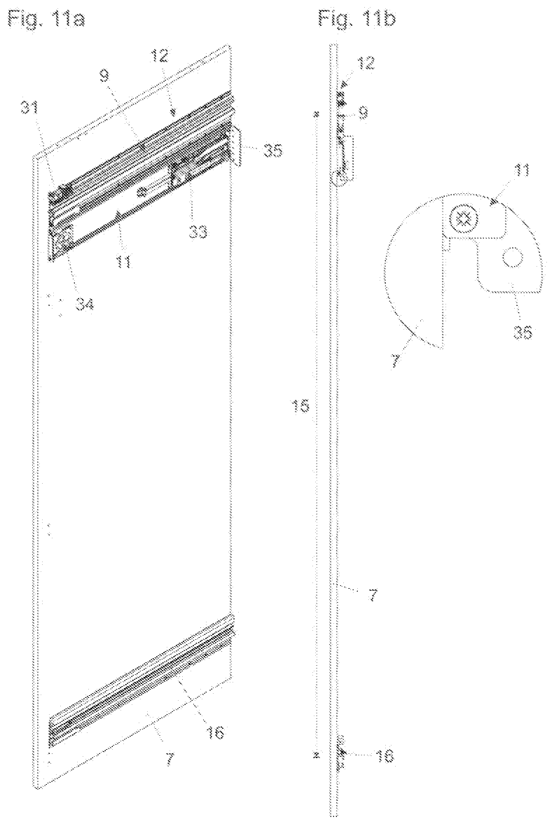

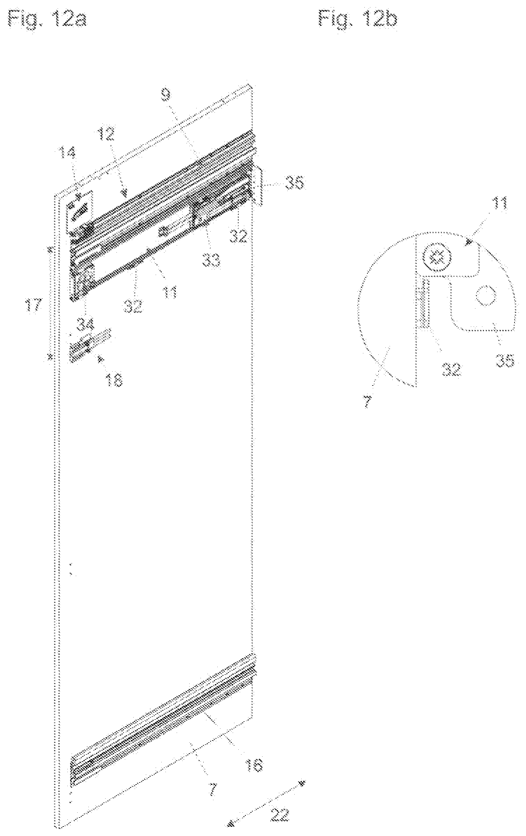

A preferred embodiment example of this method for installing a guide assembly 1 for a movable furniture part 3, which comprises at least two door leaves 5, 6 connected to each other in an articulated manner, on a furniture wall 7 of a stationary furniture part 8 is described below with reference to FIGS. 3 to 8. A preferred embodiment example of the method for installing a guide assembly 1 for a movable furniture part 2, which comprises precisely one door leaf 4, on a furniture wall 7 of a stationary furniture part 8 is then described with reference to FIGS. 9 to 14b).

FIG. 3 shows a furniture wall 3 of a stationary furniture part 8 of a piece of furniture 24, wherein a guide assembly for a movable furniture part 3 which comprises at least two door leaves 5, 6 connected to each other in an articulated manner is to be installed on the furniture wall 3. Drilled holes 30 are arranged in the furniture wall 3. Moreover, the furniture wall 3 has a cutout 51.

FIG. 4 shows the furniture wall 3 according to FIG. 3, wherein a first guide rail 9 and a third guide rail 16 are arranged on the furniture wall 3.

The third guide rail 16 is arranged at a distance 15 from the first guide rail 9.

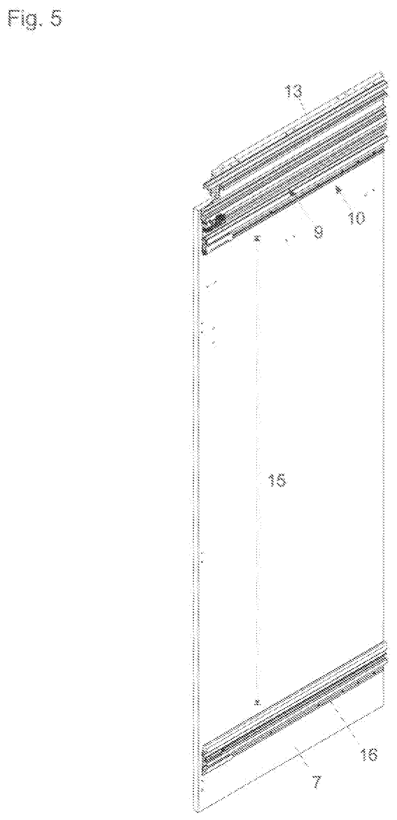

The first guide rail 9 has an adjusting device 31, with which a second guide rail 13 arranged on a long side 12 of the first guide rail 9 (cf. FIG. 5) can be adjusted in the depth direction 22 of the furniture wall 7.

FIG. 5 shows the furniture wall 3 according to FIG. 4 additionally with a second guide rail 13, wherein the second guide rail 13 is arranged on the long side 12 of the first guide rail 9 on the furniture wall 7.

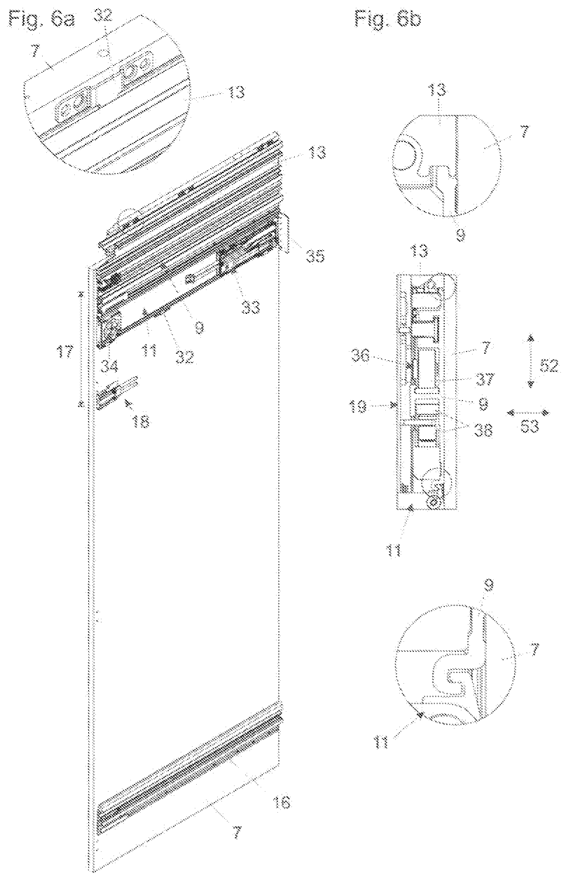

The first guide rail 9 and the second guide rail 13 are connected to each other in a positive-locking manner and displaceably (cf. also FIG. 6b)).

FIGS. 6a) and 6b) show the furniture wall 3 according to FIG. 5 additionally with a drive device 11 and a damping device 18, wherein a carrier 19 mounted displaceably on the first guide rail 9 and the second guide rail 16 is additionally represented in FIG. 6b).

The drive device 11 for influencing the movement of the movable furniture part 3 is arranged on a long side 10 (cf. FIG. 5) of the first guide rail 9, wherein the first guide rail 9 and the drive device 11 are connected to each other in a positive-locking manner (cf. FIG. 6b)).

Different embodiments of the drive device 11 are possible. The drive device 11 can be formed in such a way that it speeds up, slows down and/or uniformly moves the movable furniture part 3. The movement can be influenced over the entire route between an arrangement of the movable furniture part 3 outside a cavity 28 formed with the furniture wall 7 (cf. FIG. 1) and an arrangement of the movable furniture part 3 in an end position inside the cavity 28 formed with the furniture wall 7. Alternatively, the movement can be influenced only over one or more partial sections of this route.

In the case represented specifically, the drive device 11 comprises an ejection device 33 for ejecting the movable furniture part 3 from an end position of the movable furniture part 3 relative to the furniture wall 7. Furthermore, a cable pull 34 is provided, with which the movable furniture part 3 is movable along the first guide rail 9 from a first end position into a second end position. The application of force by the ejection device 33 and the cable pull 34 overlap each other in such a way that the movable furniture part 3 is movable from the first end position into the second end position without power assistance by a user. During a movement in the opposite direction, the ejection device 33 and the cable pull 34 are loaded again.

A holder 35 is arranged in an end-side region of the drive device 11. The function of this holder 35 is described in connection with FIG. 8.

The damping device 18 for damping a movement of the movable furniture part 3 is arranged at a distance 17 from the first guide rail 9 on the furniture wall 7.

In the case represented specifically, the damping device 18 is arranged on the furniture wall 7 in such a way that a movement of the movable furniture part 3 into an end position relative to the first guide rail 9 can be damped.

As emerges from the enlarged sections of FIG. 6a), the second guide rail 13 is fastened on the one hand to the first guide rail 9 in a positive-locking manner and on the other hand on the furniture wall 7 via holding elements 32. The fastenings make it possible to displace the second guide rail 13 relative to the first guide rail 9 by means of the adjusting device 31 (cf. FIG. 4).

The fastening of the drive device 11 on the one hand on the first guide rail 9 and on the other hand on the furniture wall 7 via holding elements 32 can be effected analogously, wherein a relative displaceability of the drive device 11 and the first guide rail 9 is, however, not provided.

As emerges from FIG. 6b), the carrier 19 is connected to the first guide rail 9 via a guide device 36. The guide device 36 comprises carrying rollers 37, via which the weight of the carrier 19 and of the movable furniture part 3 that is or can be connected to it can be supported in the vertical direction 52, and supporting rollers 38, with which the carrier 19 can be supported in the horizontal direction 53.

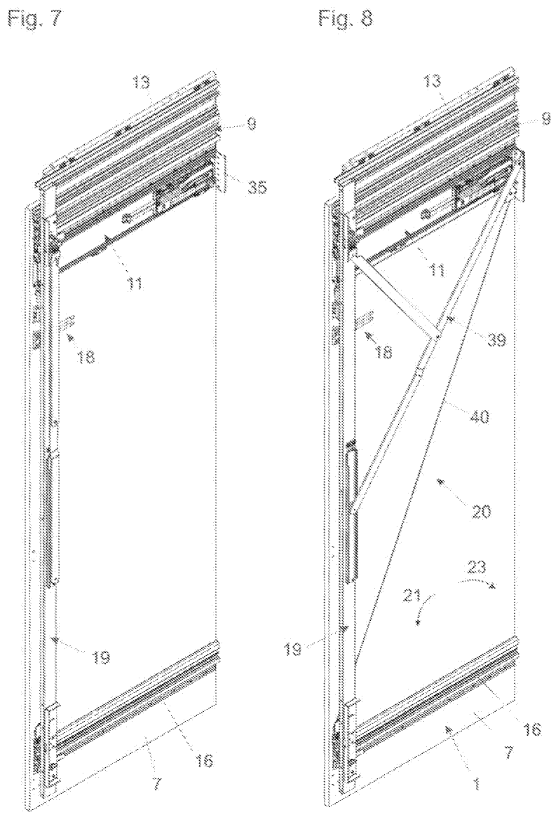

FIG. 7 shows the furniture wall 7 according to FIG. 6a) additionally with a carrier 19.

The carrier 19 for the articulated mounting of the movable furniture part 3 is mounted displaceably on the guide rails 9, 13, 16 provided. A compensation device 20 for compensating for a tilt moment 21 of the at least one carrier 19 or of the movable furniture part 3 arranged thereon about a tilt axis by a restoring moment 23 is arranged on the carrier 19.

In FIG. 8 the compensation device 20 is connected to the drive device 11, specifically to the holder 35 of the drive device 11.

Different embodiments of the compensation device 20 are possible. In the case represented specifically, the compensation device 20 comprises a scissor mechanism 39 formed Y-shaped and a cable device 40 with a pulling cable running in the shape of a Z.

The chronological sequence during the installation of the guide assembly 1 on the furniture wall 7 can be defined as follows:
1. the furniture wall 7 is provided
2. the first guide rail 9 is arranged on the furniture wall 7
3. the third guide rail 16 is arranged on the furniture wall 7
4. the second guide rail 13 is arranged on the furniture wall 7
5. the drive device 11 is arranged on the furniture wall 7
6. the damping device 18 is arranged on the furniture wall 7
7. the carrier 19 is mounted displaceably on the guide rails 9, 16, 13
8. the compensation device 20 is connected to the furniture wall 7 and/or the drive device 11.

The preferred embodiment example, illustrated with reference to FIGS. 9 to 14b), of the method for installing a guide assembly 1 for a movable furniture part 2 which comprises precisely one door leaf 4 proceeds substantially analogously to the preferred embodiment example, represented in FIGS. 3 to 8, of the method for installing a guide assembly 1 for a movable furniture part 3 which comprises at least two door leaves 5, 6 connected to each other in an articulated manner.

As a comparison shows, common parts can be used here. Thus, the same first guide rail 9, the same drive device 11, the same damping device 18 and the same carrier 19 are involved irrespective of whether the movable furniture part 2, 3 comprises precisely one door leaf 4 or at least two door leaves 5, 6 connected to each other in an articulated manner.

A difference between the two embodiment examples is that in a further method step at least one holding device 14 for holding the movable furniture part 2 in an end position relative to the first guide rail 9 on the furniture wall 7 is arranged on the second long side 12 of the first guide rail 9 (instead of the second guide rail 13), preferably wherein the first guide rail 9 and the at least one holding device 14 are connected to each other, particularly preferably in a positive-locking manner and/or displaceably.

The holding device 14 can likewise be adjustable in the depth direction 22 of the furniture wall 7 relative to the first guide rail 9 via an adjusting device 31.

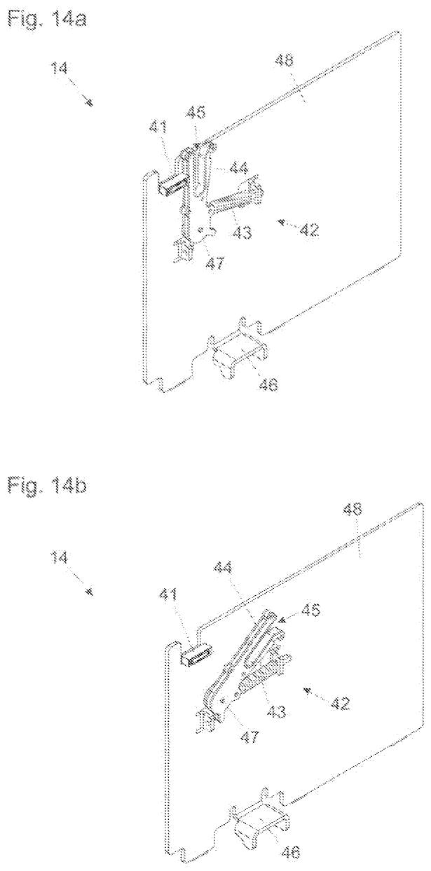

Different embodiments of the holding device 14 are possible. A preferred embodiment is shown in FIGS. 14a) and 14b), wherein FIG. 14a) shows a holding position and

FIG. 14b) shows a release position.

The holding device 14 comprises a pivot lever mechanism 42 with a pivot lever 44 mounted rotatably about a pivot pin 47 on a base body 48. The pivot lever 44 is pushed into the two end positions shown in FIGS. 14a) and 14b) via a spring device 43. A dead center position is formed between these positions. A stop 41 is provided, against which the pivot lever 44 rests in the end position according to FIG. 14a).

The pivot lever 44 has a receiver 45, into which a bolt or the like can be inserted, which is or can be connected to the movable furniture part 2 in a movement-coupled manner. In the end position according to FIG. 14a) the bolt, and thus the movable furniture part 2, is held by the spring-loaded pivot lever 44. If a user wishes to move the movable furniture part 2 out of this end position, they have to overcome the spring force of the spring device 43. The pivot lever 44 is moved beyond the dead center position and into the end position according to FIG. 14b). The bolt and thus the movable furniture part 2 are released.

On the base body 48, a coupling element 46 is provided which is in or can be brought into engagement with the adjusting device 31, as a result of which the base body 48, and thus the entire holding device 14, is displaceable relative to the first guide rail 9.

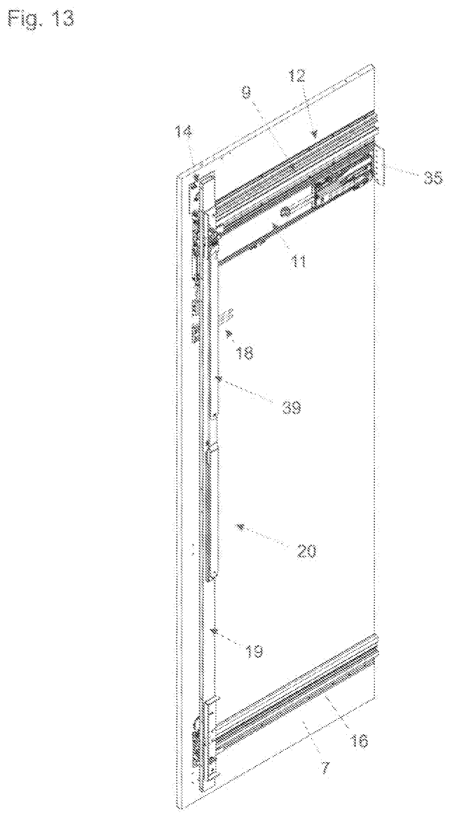

It may still be pointed out that the compensation device 20 arranged on the carrier 19 is connected to the furniture wall 7 or the drive device 11 in exactly the same way as in the preferred embodiment example in FIGS. 3 to 8 still starting from FIG. 13 (analogously to FIG. 8).

The method for installing a guide assembly 1 can be incorporated in a method for installing a piece of furniture 24, with which the pieces of furniture 24 represented in FIG. 1 or 2 for example can be installed.

Specifically, it is a method for installing a piece of furniture 24 with at least one stationary furniture part 8, at least one movable furniture part 2, 3, which comprises either precisely one door leaf 4 or at least two door leaves 5, 6 connected to each other in an articulated manner, and at least one guide assembly 1 for the movable furniture part 2, 3, wherein first the at least one guide assembly 1 is carried out according to the method according to the invention on a furniture wall 7 of the at least one stationary furniture part 8 and then the movable furniture part 2, 3 is mounted displaceably at least on the first guide rail 9, preferably indirectly via at least one carrier 19.

In the case that the movable furniture part 3 comprises at least two door leaves 5, 6 connected to each other in an articulated manner, in a further method step the at least two door leaves 5, 6 are connected to each other in an articulated manner via at least two door hinges 25 (cf. FIG. 2).

In the case that the movable furniture part 3 comprises at least two door leaves 5, 6 connected to each other in an articulated manner, in a further method step at least one transverse guide rail 26 is arranged transverse to the first guide rail 9 on the at least one stationary furniture part 8 and one of the at least two door leaves 5, 6 of the movable furniture part 3 is connected to the at least one transverse guide rail 26 via at least one carriage 50 (cf. FIG. 2).

In a further method step, the at least one transverse guide rail 26 is covered at least in regions by at least one screen element 27.

1. A method for installing a guide assembly for a movable furniture part, which comprises either precisely one door leaf or at least two door leaves connected to each other in an articulated manner, on a furniture wall of a stationary furniture part, comprising the method steps, preferably chronological in the specified sequence:
a first guide rail for guiding the movable furniture part is arranged on the furniture wall,
at least one drive device for influencing the movement of the movable furniture part on the furniture wall is arranged on a first long side of the first guide rail, preferably wherein the first guide rail and the at least one drive device are connected to each other, particularly preferably in a positive-locking manner, and
in the case that the movable furniture part comprises at least two door leaves connected to each other in an articulated manner, a second guide rail for guiding the movable furniture part on the furniture wall is arranged on a second long side of the first guide rail, preferably wherein the first guide rail and the second guide rail are connected to each other, particularly preferably in a positive-locking manner and/or displaceably.

2. The method according to claim 1, wherein the same first guide rail and/or the same drive device is involved irrespective of whether the movable furniture part comprises precisely one door leaf or at least two door leaves connected to each other in an articulated manner.

3. The method according to claim 1, wherein, in the case that the movable furniture part comprises precisely one door leaf, in a further method step at least one holding device for holding the movable furniture part in an end position relative to the first guide rail on the furniture wall is arranged on the second long side of the first guide rail, preferably wherein the first guide rail and the at least one holding device are connected to each other, particularly preferably in a positive-locking manner and/or displaceably.

4. The method according to claim 1, wherein in a further method step a third guide rail for guiding the movable furniture part on the furniture wall is arranged at a distance from the first guide rail, preferably wherein the same third guide rail is involved irrespective of whether the movable furniture part comprises precisely one door leaf or at least two door leaves connected to each other in an articulated manner.

5. The method according to claim 1, wherein in a further method step at least one damping device for damping a movement of the movable furniture part, preferably into an end position relative to the first guide rail, on the furniture wall is arranged at a distance from the first guide rail, preferably wherein the same damping device is involved irrespective of whether the movable furniture part comprises precisely one door leaf or at least two door leaves connected to each other in an articulated manner.

6. The method according to claim 1, wherein in a further method step at least one carrier for the articulated mounting of the movable furniture part is mounted displaceably on the guide rails provided, preferably wherein the same carrier is involved irrespective of whether the movable furniture part comprises precisely one door leaf or at least two door leaves connected to each other in an articulated manner.

7. The method according to claim 6, wherein at least one compensation device for compensating for a tilt moment of the at least one carrier or of the movable furniture part arranged thereon about a tilt axis by a restoring moment is arranged on the at least one carrier and in a further method step the at least one compensation device is connected to the furniture wall, preferably to the at least one drive device arranged on the furniture wall.

8. A method for installing a piece of furniture with at least one stationary furniture part, at least one movable furniture part, which comprises either precisely one door leaf or at least two door leaves connected to each other in an articulated manner, and at least one guide assembly for the movable furniture part, wherein first the at least one guide assembly is mounted according to the method according to claim 1 on a furniture wall of the at least one stationary furniture part, and then the movable furniture part is mounted displaceably at least on the first guide rail, preferably indirectly via at least one carrier.

9. The method according to claim 8, wherein, in the case that the movable furniture part comprises at least two door leaves connected to each other in an articulated manner, in a further method step the at least two door leaves are connected to each other in an articulated manner via at least two door hinges.

10. The method according to claim 8, wherein, in the case that the movable furniture part comprises at least two door leaves connected to each other in an articulated manner, in a further method step at least one transverse guide rail is arranged transverse to the first guide rail on the at least one stationary furniture part and one of the at least two door leaves of the movable furniture part is connected to the at least one transverse guide rail via at least one carriage.

11. The method according to claim 10, wherein, in a further method step, the at least one transverse guide rail is covered at least in regions by at least one screen element.
